(19) United States
(12) Patent Application Publication
(10) Pub. No.: US 2024/0428114 A1
(43) Pub. Date: Dec. 26, 2024

(54) METHOD AND SYSTEM FOR IMPROVED VARIATIONAL QUANTUM ALGORITHMS

(71) Applicant: HSBC Group Management Services Limited, London (GB)

(72) Inventors: Georgios KORPAS, London (GB); Waqas PARVAIZ, London (GB); Philip INTALLURA, London (GB); Jakub MARECEK, Prague (CZ)

(73) Assignee: HSBC Group Management Services Limited, London (GB)

(21) Appl. No.: 18/605,992

(22) Filed: Mar. 15, 2024

(30) Foreign Application Priority Data
Jun. 19, 2023 (GB) 2309193.7

(51) Int. Cl. G06N 10/60; G06F 7/556; G06N 10/20

(52) U.S. Cl. CPC G06N 10/60; G06F 7/556; G06N 10/20

(57) ABSTRACT

The present invention provides an improved method and system for variational quantum algorithms (VQA). Procedures set out herein include receiving a quantum circuit for implementing the VQA, the quantum circuit being parameterised by a set of quantum circuit parameters. A cost function for the circuit is formulated as a non-convex polynomial optimisation problem. Next moment/Sums of Squares, SOS, relaxations are applied to the non-convex polynomial optimisation problem to generate a hierarchy of semidefinite programming (SDP) relaxations that approximate the non-convex polynomial optimisation problem. These SDP relaxations are then solved using classical optimisation algorithms. The solutions are used to update the quantum circuit parameters, thereby providing an improved VQA circuit. Upon repeated iterations of the procedure, this provably converges toward the optimal VQA circuit for the problem at hand.

The present invention relates to quantum computing, specifically to improved optimization techniques and systems for variational quantum algorithms using moment/Sums of Squares (SOS) relaxations.

### BACKGROUND OF THE INVENTION

In recent years, the study of quantum algorithms has experienced a surge of interest, particularly concerning the development of efficient approaches for addressing NP-Hard optimization problems. Among these advancements, Variational Quantum Algorithms (VQAs) have emerged as a crucial category of methods, encapsulating key techniques such as the Variational Quantum Eigensolver (VQE) and the Quantum Approximate Optimization Algorithm (QAOA). A primary challenge in these hybrid quantum-classical algorithms is the classical optimization of their cost functions. Incorporating tighter bounds and better approximations for the optimization problems can enhance the performance of VQAs and broaden their applicability.

### BRIEF SUMMARY OF THE INVENTION

In short, the inventors have discovered that the performance of VQAs may be enhanced by integrating moment/Sums of Squares (SOS) relaxations within their optimization procedures. The methods and systems discussed herein leverage the strengths of moment/SOS relaxations in providing tight bounds and efficiently approximating non-convex optimization problems.

VQAs themselves find wide applicability across a range of technical fields. In particular, optimisation problems in the space of chemistry and material science, and even to more abstract applications such as machine learning, finance and computer science. Specifically, they have been suggested as candidates alternative to quantum annealing and more broadly to simulated annealing or other classical heuristic methods. One can potentially envision them also in the context of finance for applications of the likes of portfolio optimization, for example.

Generally, though VQAs remain heuristic methods and they are considered by the community for optimization problem instances where the resource requirements are too heavy for classical optimizers given the hope that quantum effects can make such problems amenable to quantum instead. Mathematically speaking, any form of mixed integer linear program found in any technical field can be mapped to some form of VQA.

The disclosed embodiments present a novel approach to enhance the performance of Variational Quantum Algorithms (VQAs) by integrating moment/Sums of Squares (SOS) relaxations within the optimization procedures. As will be apparent, this is a different approach compared to traditional methods in the following ways:
Traditional VQAs mainly focus on the hybrid quantum-classical optimization of their cost functions without reformulating them as polynomial optimization problems by utilizing heuristic training techniques. The disclosed method reformulates the cost function as a polynomial optimization problem, enabling the application of moment/SOS relaxations.
Traditional VQAs do not typically employ moment/SOS relaxations as part of their optimization process. The proposed method integrates moment/SOS relaxations to generate a hierarchy of semidefinite programming (SDP) relaxations, which provide increasingly tighter lower bounds on the optimal solution as the level of relaxation increases.

We emphasize that a core development here is that the present disclosure is directed at developing the VQA class of algorithms to better use limited Noisy Intermediate-Scale Quantum (NISQ) computer resources which are currently available (and to which we expect to be limited in the near term at least). For example, two core limitations of such NISQ systems are that they are noisy, leading to a practical limit on circuit depth (number of consecutive gates acting on qubits), and intermediate scale, which limits the available compute resources (e.g. number of qubits, etc.; total number of gates implementable; number of qubits over which gates can operate and so forth). For this reason, it is important that optimal, or at least improved, VQA circuits can be identified and implemented for the given problem being addressed, since it is not always clear how to provide an optimal circuit given the limitations on depth and complexity. I other words, we seek a circuit which performs the desired algorithm, without contravening the limitations on noise and complexity (e.g. what is the least deep circuit we can use to achieve the result). Therefore, the present disclosure should be viewed as an improvement in the fundamental uses of quantum computation, rather than being limited to the specific examples discussed herein.

Conventional classical computers are limited in their ability to solve certain complex problems due to their binary processing nature. Quantum computing is a promising technology that has the potential to overcome these limitations and solve complex problems exponentially faster. Variational quantum algorithms are a class of quantum algorithms that use quantum circuits to solve optimization problems, and have shown great potential in various applications. The methods and systems set out herein aim to improve the quality of approximations and accelerate the convergence of the hybrid quantum-classical optimization process.

To these ends, disclosed herein is a method for improving the performance of a variational quantum algorithm, VQA, the method comprising the steps of: (a) receiving a quantum circuit for implementing the VQA, the quantum circuit being parameterised by a set of quantum circuit parameters; (b) formulating a cost function of the VQA as a polynomial optimisation problem; (c) applying moment/Sums of Squares, SOS, relaxations to the polynomial optimisation problem to generate a hierarchy of semidefinite programming, SDP, relaxations that approximate the polynomial optimisation problem; (d) solving the SDP relaxations using classical optimisation algorithms; and (e) updating the quantum circuit parameters of the variational quantum algorithm based on the solution of the SDP relaxations.

In this context, “quantum circuit parameters” refer to data on the encoding of qubits, connectivity between qubits, arrangements of gates for manipulating the qubit states, and so forth. Also, in the context of post quantum cryptography, the parameters may relate to circuits where free parameters that can be tuned in a certain way are allowed (i.e. they are not pre-fixed as in the case of fault tolerant algorithms).

The moment/SOS relaxations are used to improve the quality of approximations and accelerate the convergence of the hybrid quantum-classical optimisation process thereby providing increasingly tighter lower bounds on the optimal solution as the level of relaxation is increased. In other words the output of this process is an improved VQA circuit.

By formulating the cost function of a VQA as a polynomial optimization problem and applying moment/SOS relaxations, a hierarchy of semidefinite programming (SDP) relaxations is constructed. These SDP relaxations provide a converging sequence of lower bounds for the optimization problem and can be solved using efficient classical algorithms. The solution of the SDP relaxations is then employed to update the parameters of the quantum circuits used in the VQAs.

The present disclosure therefore introduces a ground-breaking method for incorporating moment/Sums of Squares relaxations into the optimization procedure of variational quantum algorithms. This innovative approach results in improved approximations, accelerated convergence, and enhanced performance in addressing NP-Hard optimization problems, opening new avenues for research and practical applications in quantum computing.

In this way moment/Sums of Squares (SOS) relaxations are integrated within the optimization procedure of variational quantum algorithms, resulting in improved approximations, accelerated convergence, and enhanced performance. Instead of solely relying on gradient-based or other classical optimization techniques, the disclosed methods and systems incorporate classical optimization algorithms to solve the SDP relaxations generated by the moment/SOS relaxations. This integration results in improved approximations and accelerated convergence. The disclosed method updates the parameters of the quantum circuits employed in the VQAs based on the solution of the SDP relaxations. This iterative process, guided by the moment/SOS relaxations, leads to enhanced approximations, faster convergence of the hybrid quantum-classical optimization process, and improved overall performance, thereby expanding the applicability of VQAs to a wider range of NP-Hard optimization problems.

Previous work in this space has focused on simple optimisations which use many iterations of a loop to converge. Using modern high-performance computers, this can be a fast and scalable process, however it cannot guarantee that a global optimum is found, often providing an improvement, but one which sits at a local optimum. By contrast, the present procedures are deterministically and provably directed toward finding a global optimum, a useful trait where the optimisation landscape has big number of local minima, albeit at the cost of greater computational complexity being required along with a corresponding reduction in scalability. This trade-off is made for the benefit of guaranteed convergence on the optimal solution, although longer run times may be expected. An assumption is made that the cost function can be cast as a polynomial, although this is usually possible by making some simplifications or applying other mathematical tricks. The process is suitable for performing optimisation at an “operator” level (i.e. viewing the elements of the cost matrix as parametrised operators). In principle, the present optimisation loop may be run only one time and still result in progress toward (or even arrival at) the optimum solution.

Optionally the variational quantum algorithm includes the Variational Quantum Eigensolver (VQE) and/or the Quantum Approximate Optimisation Algorithm (QAOA). These are important classes of algorithm in the field of quantum information and represent a key area for optimisation.

Optionally, the cost function includes physics-informed constraints. These constraints provide a clear way to apply limitations to the VQA and thereby to improve the circuit for enacting the specific VQA algorithm being considered. As an example, in cases where the VQA circuit is represented by a bounded Hamiltonian, energy gaps in the system are examples of physics-informed constraints which can help to accurately represent the system.

Optionally, the polynomial optimisation problem is formulated using a combination of monomials, polynomials, and constraints that represent the cost function of the variational quantum algorithm. These formulations are readily amenable to optimisation procedures and therefore represent a convenient recasting of the problem.

Optionally, the hierarchy of SDP relaxations is generated by successively increasing the level of moment/SOS relaxations, each level providing a tighter lower bound on the optimal solution. In this way, a progressively better solution is derived by increasing the relaxation level.

Optionally, the classical optimisation algorithms for solving the SDP relaxations include interior-point methods, gradient-based methods. These techniques are readily applicable to the general class of problems investigated herein.

Optionally, the quantum circuit parameters are randomised to provide the input in step (a). This removes any bias in setting up the input circuit and can help the convergence process.

Optionally, steps (a) to (e) of the method are repeated for one or more further iterations. Updating the quantum circuit parameters in this way, using an iterative process that incorporates the results of the SDP relaxations, leads to progressively better VQA circuits. In some cases the quantum circuit parameters are only randomised on the first iteration and wherein on subsequent iterations the parameters output in step (e) are used to construct the input quantum circuit. This leads to a progressive improvement in the quantum circuit parameters.

Optionally, the iterations are performed until the quantum circuit parameters are within a user defined threshold of the optimum value. It is a surprising result of the present invention that not only does the process provably converge asymptotically toward the optimum VQA circuit parameters, but further that information on how close any particular circuit is to that optimum. Therefore, a user can decide in advance how close would be acceptable (which is a trade-off between accuracy and compute time) and then run the procedure until the result is no further from optimum than that distance. This information is simply not available in known methods, and represents a significant advantage in cases where accuracy is important and time is available to run the computationally complex (classical) optimisation process.

Optionally, step (b) is performed on a noisy intermediate-scale quantum, NISQ, device. As noted above, the methods disclosed herein are suitable for operation on current and near-term quantum computers, even given the limitations of the NISQ regime.

The disclosure also extends to an apparatus for improving the performance of variational quantum algorithms, VQAs, the apparatus comprising: a quantum computing system configured to execute variational quantum algorithms; a classical computing system configured to perform moment/SOS relaxations and semidefinite programming (SDP) relaxations; wherein the apparatus is configured to execute the methods discussed herein.

The apparatus may also include a memory storage unit configured to store the optimization parameters, cost function representations, moment/SOS relaxation hierarchy, and intermediate results from both quantum and classical optimization processes.

In addition, a processing unit may be provided within the classical computing system, capable of executing classical optimization algorithms to solve the SDP relaxations and provide increasingly tighter lower bounds on the optimal solution as the level of relaxation is increased.

Optionally, the quantum computing system and the classical computing system work together in a hybrid quantum-classical framework to perform the optimisation process. The use of a hybrid system in this way leverages the best qualities of each type of processor (quantum or classical), and provides a tractable way to drive the quantum circuit toward optimality.

Optionally, the apparatus further includes a communication interface configured to transmit the solution of the SDP relaxations to the quantum computing system and receive updated quantum circuit parameters from the quantum computing system.

Optionally, the apparatus further includes a control unit for integration of moment/SOS relaxations within the variational quantum algorithm optimisation procedure by coordinating the quantum computing system and classical computing system. This control unit provides oversight over the process and allows for consistent and coherent control over the procedure.

Optionally, the apparatus further includes a user interface for allowing a user to select the variational quantum algorithm to be employed and/or setting parameters for the moment/SOS relaxations. This is a convenient way for a user to interact with, and control, the system.

The disclosure also extends to a non-transitory, computer readable medium comprising instructions which cause a hybrid quantum-classical computation system to perform the methods discussed herein.

### BRIEF DESCRIPTION OF THE DRAWINGS

FIG. 1 illustrates a prior art VQA optimisation technique;

FIG. 2 illustrates the improved optimisation technique of the present disclosure;

FIG. 3 is a flow chart illustrating the steps in the methods disclosed herein; and

FIG. 4 is a schematic of a hybrid quantum-classical computation system for enacting the methods set out herein.

### DETAILED DESCRIPTION OF THE INVENTION

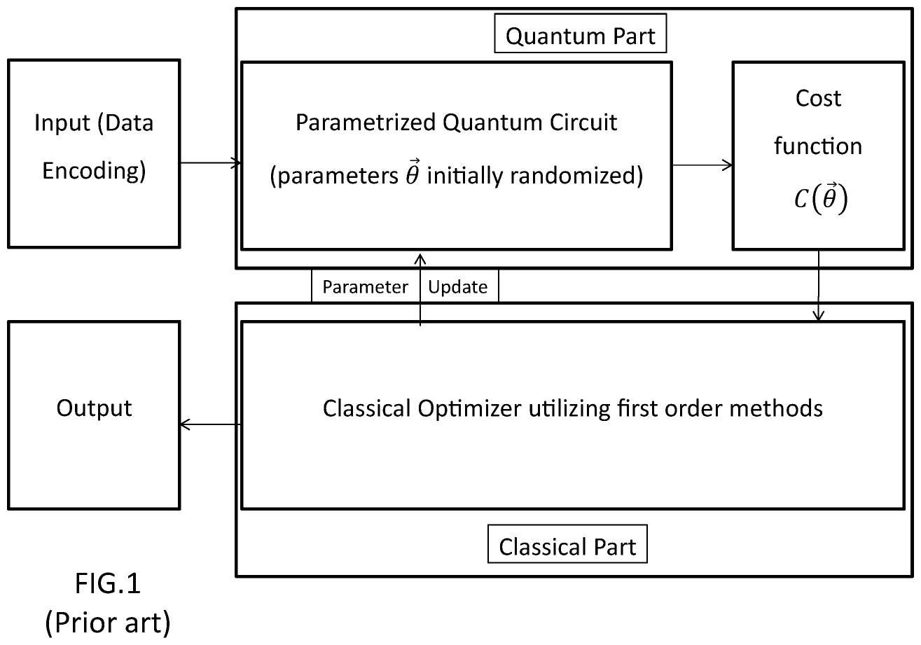

Previous methods are shown in general in FIG. 1. Here a quantum circuit parameterised by quantum circuit parameters is input and a cost function is derived form this. This process occurs on a quantum computer. Next, the cost function is passed to a classical computer, on which a classical optimisation procedure using first order methods (for example stochastic gradient descent). The output of this is a set of updated quantum circuit parameters, which are then fed back into the quantum computer as a new input circuit. This loop is iterated repeatedly until a stable point is found (e.g. changes in the quantum circuit parameters between successive loops drops below a chosen threshold). This approach uses simple optimisations, leveraging the high throughput of modern high-performance computers, meaning that each iterative loop is reasonably fast to execute. However, it is prone to finding local optima, and cannot guarantee that a global optimum is found.

As an example, in QAOA processes (a type of VQA) a circuit is prepared which has the form of a set of unitary operators, Û_{B}(β)=e^{iβ\hat{B}} and Û_{C}(γ)=e^{iγ\hat{B}} applied repeatedly with varying parameters to an initial state, |s [symbol] , i.e. |\vec{β},\vec{γ} [symbol] =Û_{B}(βₚ)Û_{C}(γₚ) . . . Û_{B}(β₁)Û_{C}(γ₁)|s [symbol] with a view to maximising/minimising the expectation value [symbol] \vec{β},\vec{γ}|Ĉ|\vec{β},\vec{γ} [symbol] by adjusting the parameters encoded in \vec{B} and \vec{γ}. The value of p sets the number of operations performed and acts to mimic adiabatic evolution. At the end of the process, this circuit is measured. The parameters (2p in total) are then optimized classically using stochastic methods like simultaneous perturbation stochastic approximation, similar to the approach taken in machine learning. Then, the new parameters are fed to the original circuit and the process starts again. This process lacks availability of knowledge as to how good these newly found parameters actually are, and is susceptible in particular to settling in local optima.

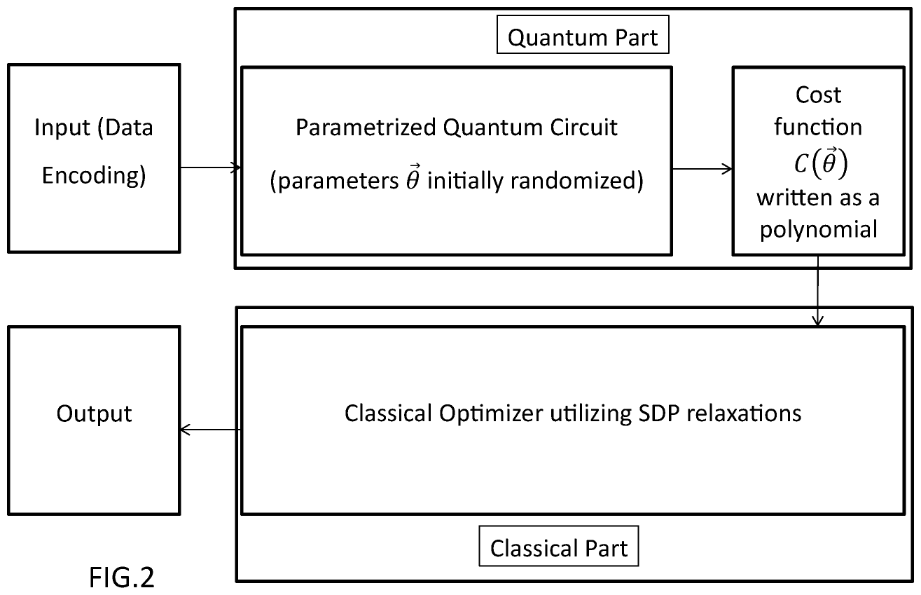

By contrast, the presently disclosed procedure is shown in FIG. 2. Here, the quantum circuit is again input onto a quantum computer and a cost function is derived, but crucially the cost function is written as a polynomial, either by virtue of the problem to be solved or more commonly by identifying a suitable polynomial form of it. This allows the cost function to be optimised using SDP relaxation methods, such as the moment/SOS relaxations discussed in detail elsewhere herein. Since this provably drives the circuit parameters toward a global optimum, the longer optimisation runtime is compensated by needing fewer (and in some cases only a single) iterations to asymptotically converge toward an optimum, and importantly, the optimum achieved in this way is truly a global optimum. The convergence occurs in sub-exponential (and often in linear) time.

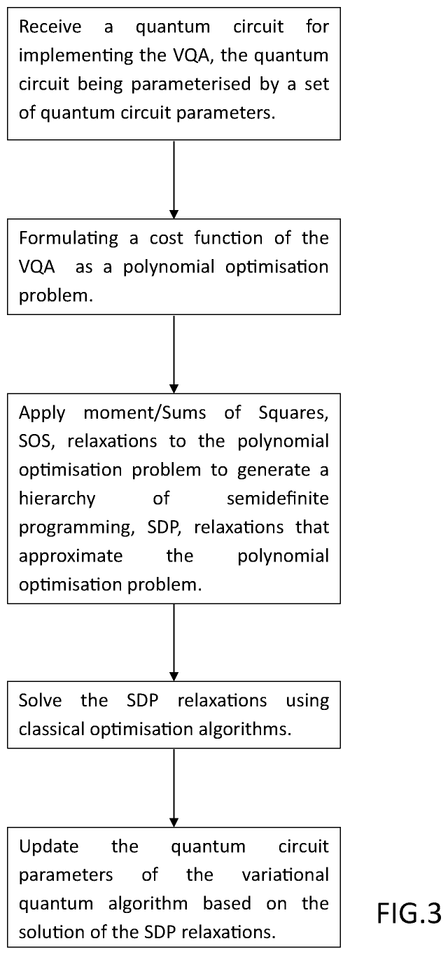

In FIG. 3, the present method is set out in more detail. In a first step, a quantum circuit for implementing the VQA is received, the quantum circuit being parameterised by a set of quantum circuit parameters.

Next, the cost function of the VQA is provided in the form of a polynomial optimisation problem. Formulating the cost function as a polynomial optimization problem requires expressing the cost function using a combination of monomials, polynomials, and constraints that accurately represent the problem at hand. This reformulation enables the application of moment/SOS relaxations to the cost function, which are particularly well-suited for handling polynomial optimization problems.

In general, costs in VQA encoding may be thought of as a multidimensional hypersurface sometimes referred to as the cost landscape, with the optimisation procedure seeking a global optimum, i.e. the maximum or minimum of the hypersurface. The most general form of the cost function is:

C(θ)=f({ρₖ},{Oₖ},U(θ))

in which f is some function, U(θ) is a parametrised unitary, θ is composed of discrete and continuous parameters, {ρₖ} are input states from a trailing set and {Oₖ} are a set of observables. This can conveniently be expressed in the form:

$$C ( θ ) = {\sum }_{k} {f}_{k} ( Tr [ {O}_{k} U ( θ ) {ρ}_{k} {U}^{†} ( θ ) ] )$$

Specifically, in the present example, given the analytic form of a quantum observable of interest (a Hermitian operator) O, our reformulation expresses the problem's cost function C(θ), as a polynomial in the parameters \vec{θ}∈ [symbol] ^{M}:

$$C ( θ ) = {\sum }_{i = 0}^{N} {c}_{i} {\prod }_{j = 1}^{M} {cos}^{{α}_{i , j}} ( {θ}_{j} ) {sin}^{{β}_{i , j}} ( {θ}_{j} ) \qquad ( 1 )$$

where θ=[θ₁, θ₂, . . . , θ_{M}]^{T} represents the vector of circuit parameters, N is the total number of terms in the polynomial, M is the number of parameters in the quantum circuit, cᵢ are the coefficients of each term in the polynomial, and α_{i,j} and β_{i,j} are the exponents of the cosine and sine functions, respectively, for the j^{th} parameter in the i^{th} term. In general, the specific form of the polynomial will depend on the particular optimization problem being solved using the VQA, but this general approach captures the range of possibilities.

In a third step, moment/Sums of Squares, SOS, relaxations are applied to the polynomial optimisation problem to generate a hierarchy of semidefinite programming, SDP, relaxations that approximate the polynomial optimisation problem. By successively increasing the level of moment/SOS relaxations, a hierarchy of semidefinite programming (SDP) relaxations is generated. Each level in the hierarchy corresponds to a convex optimization problem, providing a tighter lower bound on the optimal solution. The hierarchy converges to the true optimal solution as the level of relaxation increases. Concretely, let P be the polynomial optimization problem representing the cost function of the variational quantum algorithm:

$${min}_{x} {p}_{0} ( x ) \qquad ( 2 )$$

$$such that$$

$${p}_{i} ( x ) \geq 0 ; i = 1 , … , m$$

where x∈ [symbol] ⁿ, p₀(x) is the objective function and pᵢ(x) are the constraint functions. The SOS relaxations at level r yield a sequence of lower bounds on the optimal solution, denoted by αᵣ:

$${α}_{1} \leq {α}_{2} \leq ⋯ \leq {α}_{r} \leq ⋯ \leq {α}^{*} \qquad ( 3 )$$

where α* is the true optimal solution of problem (1). Applying moment/SOS relaxations to problem (1) generates a hierarchy of SDP relaxations:

$${min}_{x} {p}_{0} ( x ) \qquad ( 4 )$$

$$such that$$

$${p}_{i} ( x ) - {σ}_{i} ( x ) \geq 0 ; i = 1 , … , m$$

where σᵢ (x) are sums of squares (SOS) polynomials. The hierarchy of SDP relaxations converges to the true optimal solution as the level of relaxation r increases. In the absence of constraints the problem reads:

$${min}_{x} {p}_{0} ( x ) \qquad ( 5 )$$

where x∈ [symbol] ⁿ, p₀(x) is the objective function, as before. Applying moment/SOS relaxations to problem (1) generates a hierarchy of SDP relaxations:

$${min}_{x} {p}_{0} ( x ) \qquad ( 6 )$$

$$such that$$

$${p}_{0} ( x ) - σ ( x ) \geq 0 ;$$

where σ(x) is again an SOS polynomial. The SOS relaxations at level r yield a sequence of lower bounds on the optimal solution, denoted by αᵣ:

$${α}_{1} \leq {α}_{2} \leq ⋯ \leq {α}_{r} \leq ⋯ \leq {α}^{*} \qquad ( 7 )$$

In the context of the VQA studied herein we identify x with θ and α* with the optimal solution of the VQA: C*(θ).

A fourth step is then performed in which the SDP relaxations are solved using classical optimisation algorithms. Once the hierarchy of SDP relaxations is generated, the relaxations are solved using classical optimization algorithms. Various techniques can be employed for this purpose, including interior-point methods, gradient-based methods, and other convex optimization approaches. The classical optimization algorithms provide increasingly tighter lower bounds on the optimal solution as the level of relaxation increases, leading to improved approximations and accelerated convergence.

Finally, in a fifth step, the quantum circuit parameters of the variational quantum algorithm are updated based on the solution of the SDP relaxations. This involves updating the parameters of the quantum circuits employed in the VQA based on the solution of the SDP relaxations. This update can for example be performed using an iterative process that incorporates the results of the SDP relaxations. As the optimization procedure progresses and the relaxations provide tighter lower bounds on the optimal solution, the quantum circuit parameters are updated accordingly to achieve better approximations.

In the parametrization of the cost function presented in Eq. 1 the polynomial is “trigonometric”. The invention is applicable to various VQAs, including but not limited to the Variational Quantum Eigensolver (VQE) and the Quantum Approximate Optimization Algorithm (QAOA). The optimization procedure is robust in the presence of noise and is compatible with noisy intermediate-scale quantum (NISQ) devices.

The moment/SOS relaxations are used to improve the quality of approximations and accelerate the convergence of the hybrid quantum-classical optimisation process thereby providing increasingly tighter lower bounds on the optimal solution as the level of relaxation is increased. In other words the output of this process is an improved VQA circuit. The hierarchy of SDP relaxations is generated by successively increasing the level of moment/SOS relaxations, each level providing a tighter lower bound on the optimal solution. In this way, a progressively better solution is derived by increasing the relaxation level. Even a single iteration of this process can lead to substantial advantages, but in some examples, the process is repeated. The input parameters for the quantum circuit may be randomised for the first (and potentially the only) iteration. Subsequent iterations may then use the parameters output in step (e) to construct the input quantum circuit. This leads to a progressive improvement in the quantum circuit parameters.

By formulating the cost function of a VQA as a polynomial optimization problem and applying moment/SOS relaxations, a hierarchy of semidefinite programming (SDP) relaxations is constructed. These SDP relaxations provide a converging sequence of lower bounds for the optimization problem and can be solved using efficient classical algorithms. The solution of the SDP relaxations is then employed to update the parameters of the quantum circuits used in the VQAs.

The way this works is by taking as input a polynomial optimization problem and converting it into a series of convex SDPs (semidefinite programs) of higher and higher accuracy in the order of these series. So the result improves as higher levels of these series are considered until the global optimum is reached. While in hard problems this might be slow, there are many techniques (e.g. sparsity) which can be applied to make the problem more tractable. Furthermore, it is possible to use this process in order to identify how far from the global optimum the system is at any given moment. In many cases, it is far less important that the problems to be solved are solved quickly, than it is for them to be solved accurately. In such cases, the present methods show significant advantages over other known processes.

The variational quantum algorithm addressed in FIG. 3 can include e.g. the Variational Quantum Eigensolver (VQE) and/or the Quantum Approximate Optimisation Algorithm (QAOA). Moreover, the cost function may be adapted to include physics-informed constraints. In general, VQAs are designed to handle unconstrained optimisation problems. However, the following situations are ones in which incorporating constraints in the cost function of the VQA can be beneficial:
(a) In certain problem domains, the underlying optimization problem naturally contains constraints that must be satisfied. By incorporating these constraints directly into the cost function, the VQA can be adapted to handle such structured problems more effectively.
(b) Often, adding constraints can help regularize the optimization problem, preventing overfitting, and improving the generalization capability of the VQA. Regularization techniques can be particularly useful when dealing with high-dimensional parameter spaces, ill-conditioned cost functions, or noisy data.
(c) Including constraints in the cost function can help ensure that the solutions obtained by the VQA are feasible and satisfy the desired properties. This can be particularly relevant when dealing with problems where the feasible region is limited or has specific structural characteristics.
(d) When combining VQAs with other optimization techniques or heuristics, it might be advantageous to incorporate constraints in the cost function to facilitate the interaction between different methods and improve the overall performance of the hybrid approach.

The polynomial optimization problem may for example be formulated using a combination of monomials, polynomials, and constraints that represent the cost function of the variational quantum algorithm. These formulations are readily amenable to optimization procedures and therefore represent a convenient recasting of the problem.

The method opens new avenues for research and practical applications in quantum computing by enhancing the performance of variational quantum algorithms. By incorporating moment/SOS relaxations into the optimization procedure, improved approximations, accelerated convergence, and a wider applicability to NP-Hard optimization problems can be achieved.

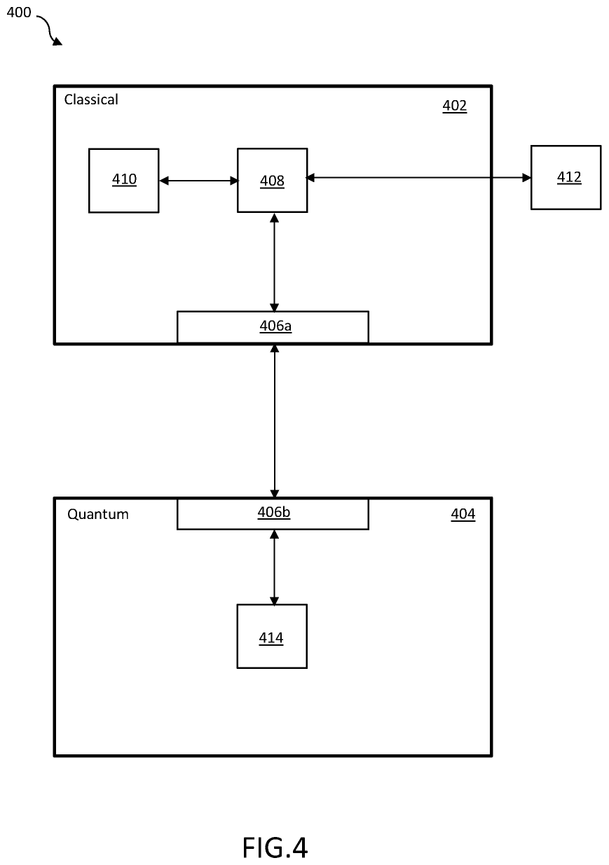

Turning now to FIG. 4, an apparatus 400 for enacting the methods disclosed herein is shown. The apparatus 400 has a classical processing system 402 and a quantum processing unit 404. The classical and quantum processing systems 402, 404 each have a respective communications interface 406a,b to enable communications between them. In addition, the classical processing system 402 has a memory 410, a processor 408 and a user interface 412. Although not shown in detail, the quantum processing system 404 has quantum hardware 414 for example including an array of qubits and a series of controllable quantum gates to allow controlled interactions between the states, as well as hardware to allow the qubits to be initialized in an initial state, and measurement apparatus to allow measurements of the quantum states of the qubits to be read once a calculation has been performed. The qubit may be any suitable substrate, such as quantum dots, atomic systems, semiconductor systems, superconducting systems, or photonic systems.

In operation, a user interacts with the user interface 412 to set up the variational quantum algorithm to be employed. In addition, parameters for the moment/SOS relaxations may also be provided by the user. In some examples, a user interface 412 is not necessary, however, since the problem and constraints may be transmitted to the apparatus 400 in complete form from a remote location or read directly from memory (e.g. memory 410).

The information setting up the problem is received by the processor 408, which may communicate with memory 410 to store the problem or for use as a cache to allow the processor to manipulate the problem. The memory may also store the optimization parameters, cost function representations, moment/SOS relaxation hierarchy, and intermediate results from both quantum and classical optimization processes, and so forth. Part of the manipulations may include, for example, converting the problem and parameters from human-readable instructions to machine-interpretable code, and on into control signals for preparing the quantum circuit (in accordance with the quantum circuit parameters) to enact the necessary operations. Once ready, the classical processing system 402 communicates the suitably phrased problem to its communications interface 406a, and transmits it to the quantum processing system 404, via the communications interface 406b provided to the quantum processing system 404.

Once the information is received, the quantum processing system 404 encodes the problem onto its qubits and sets up a suitable set of quantum gates to enact the circuit according to the quantum circuit parameters. The quantum processing system 404 then generates the cost function for the quantum circuit in the form of a polynomial. Once achieved, the quantum processing system 404 passes the result back to the classical processing system 402 via the communications interfaces 406a,b.

The processor 408 is then able to execute classical optimization algorithms to solve the SDP relaxations and provide increasingly tighter lower bounds on the optimal solution as the level of relaxation is increased. In this way, the quantum computing system and the classical computing system work together in a hybrid quantum-classical framework to perform the optimization process. The use of a hybrid system in this way leverages the best qualities of each type of processor (quantum or classical) and provides a tractable way to drive the quantum circuit toward optimality.

Once an improved set of circuit parameters has been obtained, they may be transmitted to a remote location, stored in memory 410, passed to the user interface 412, or used to initialize a subsequent iteration of the process.

In some cases, the apparatus further includes a control unit (not shown) for integration of moment/SOS relaxations within the variational quantum algorithm optimization procedure by coordinating the quantum computing system and classical computing system. This control unit provides oversight over the process and allows for consistent and coherent control over the procedure.

Finally, the disclosure also extends to a non-transitory, computer readable medium comprising instructions which cause a hybrid quantum-classical computation system to perform the methods discussed herein.

1. A method for improving the performance of a variational quantum algorithm, VQA, the method comprising the steps of:
(a) receiving a quantum circuit for implementing the VQA, the quantum circuit being parameterised by a set of quantum circuit parameters;
(b) formulating a cost function of the VQA as a polynomial optimisation problem;
(c) applying moment/Sums of Squares, SOS, relaxations to the polynomial optimisation problem to generate a hierarchy of semidefinite programming, SDP, relaxations that approximate the polynomial optimisation problem;
(d) solving the SDP relaxations using classical optimisation algorithms; and
(e) updating the quantum circuit parameters of the variational quantum algorithm based on the solution of the SDP relaxations.

2. The method of claim 1, wherein the variational quantum algorithm includes the Variational Quantum Eigensolver (VQE) and/or the Quantum Approximate Optimisation Algorithm (QAOA).

3. The method of claim 1, wherein the cost function includes physics-informed constraints.

4. The method of claim 1, wherein the polynomial optimisation problem is formulated using a combination of monomials, polynomials, and constraints that represent the cost function of the variational quantum algorithm.

5. The method of claim 1, wherein the hierarchy of SDP relaxations is generated by successively increasing the level of moment/SOS relaxations, each level providing a tighter lower bound on the optimal solution.

6. The method of claim 1, wherein the classical optimisation algorithms for solving the SDP relaxations include interior-point methods, gradient-based methods.

7. The method of claim 1, wherein the quantum circuit parameters are randomised to provide the input in step (a).

8. The method of claim 7, wherein steps (a) to (e) of the method are repeated for one or more further iterations.

9. The method of claim 8, wherein the quantum circuit parameters are only randomised on the first iteration and wherein on subsequent iterations the parameters output in step (e) are used to construct the input quantum circuit.

10. The method of claim 8, wherein the iterations are performed until the quantum circuit parameters are within a user defined threshold of the optimum value.

11. The method of claim 1, wherein step (b) is performed on a noisy intermediate-scale quantum, NISQ, device.

12. An apparatus for improving the performance of variational quantum algorithms, VQAs, the apparatus comprising:
a quantum computing system configured to execute variational quantum algorithms; and
a classical computing system configured to perform moment/SOS relaxations and semidefinite programming (SDP) relaxations,
wherein the apparatus is configured to execute the method steps of claim 1.

13. The apparatus of claim 12, wherein the quantum computing system and the classical computing system work together in a hybrid quantum-classical framework to perform the optimisation process.

14. The apparatus of claim 12, further including a communication interface configured to transmit the solution of the SDP relaxations to the quantum computing system and receive updated quantum circuit parameters from the quantum computing system.

15. The apparatus of claim 12, further comprising a control unit for integration of moment/SOS relaxations within the variational quantum algorithm optimisation procedure by coordinating the quantum computing system and classical computing system.

16. The apparatus of claim 12, further comprising a user interface for allowing a user to select the variational quantum algorithm to be employed and/or setting parameters for the moment/SOS relaxations.

17. A non-transitory, computer readable medium comprising instructions which cause a hybrid quantum-classical computation system to perform the method of claim 1.
